(19) United States
(12) Patent Application Publication
(10) Pub. No.: US 2015/0237005 A1
(43) Pub. Date: Aug. 20, 2015

(54) ADDRESS PROCESSING

(71) Applicant: Hangzhou H3C Technologies Co., Ltd., Hangzhou, Zhejiang (CN)

(72) Inventor: Yuan Tian, Beijing (CN)

(21) Appl. No.: 14/403,854

(22) PCT Filed: Aug. 14, 2013
(86) PCT No.: PCT/CN2013/081434

§ 371 Date: Nov. 25, 2014

(30) Foreign Application Priority Data
Oct. 29, 2012 (CN) 201210422493.9

(51) Int. Cl. H04L 29/12

(52) U.S. Cl. CPC H04L 61/2061; H04L 61/2015; H04L 61/6022

(57) ABSTRACT

According to an example, an address may be processed through snooping, by a network device, of a packet sent from a DHCP client for confirming whether an IP address is available and recording a temporary snooping table item associated with the IP address according to the snooped packet. In addition, at least one packet for applying for the IP address may be generated according to the snooped packet, a DUID of a DHCP server may be added to the at least one packet for applying for the IP address and the at least one packet may be sent to a DHCP server. In response to the DHCP server confirming that the IP address is available, at least one reply packet may be received from the DHCP server and the IP address may be recorded.

### BACKGROUND

A Dynamic Host Configuration Protocol (DHCP) adopts a client/server communication mode. In this protocol, a DHCP client sends a configuration request, such as a configuration request for applying for an IP address, to a DHCP server. The DHCP server sends configuration information, such as the IP address, requested by the DHCP client to the DHCP client to dynamically configure the configuration information.

### BRIEF DESCRIPTION OF THE DRAWINGS

Features of the present disclosure are illustrated by way of example and not limited in the following figure(s), in which like numerals indicate like elements, in which:

FIG. 1 is a schematic diagram illustrating a structure of a network including a DHCP snooping device in accordance with an example of the present disclosure;

FIG. 2 is a flow chart illustrating a method in accordance with an example of the present disclosure;

FIG. 3 is a flow chart illustrating block 202 depicted in the flow chart of FIG. 2 in accordance with an example of the present disclosure;

FIG. 4 is a schematic diagram illustrating a structure of a first network device in accordance with an example of the present disclosure; and

FIG. 5 is a schematic diagram illustrating a second network device in accordance with an example of the present disclosure.

### DETAILED DESCRIPTION

For simplicity and illustrative purposes, the present disclosure is described by referring mainly to non-limiting examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used throughout the present disclosure, the term “includes” means includes but not limited to, the term “including” means including but not limited to. The term “based on” means based at least in part on. In addition, the terms “a” and “an” are intended to denote at least one of a particular element.

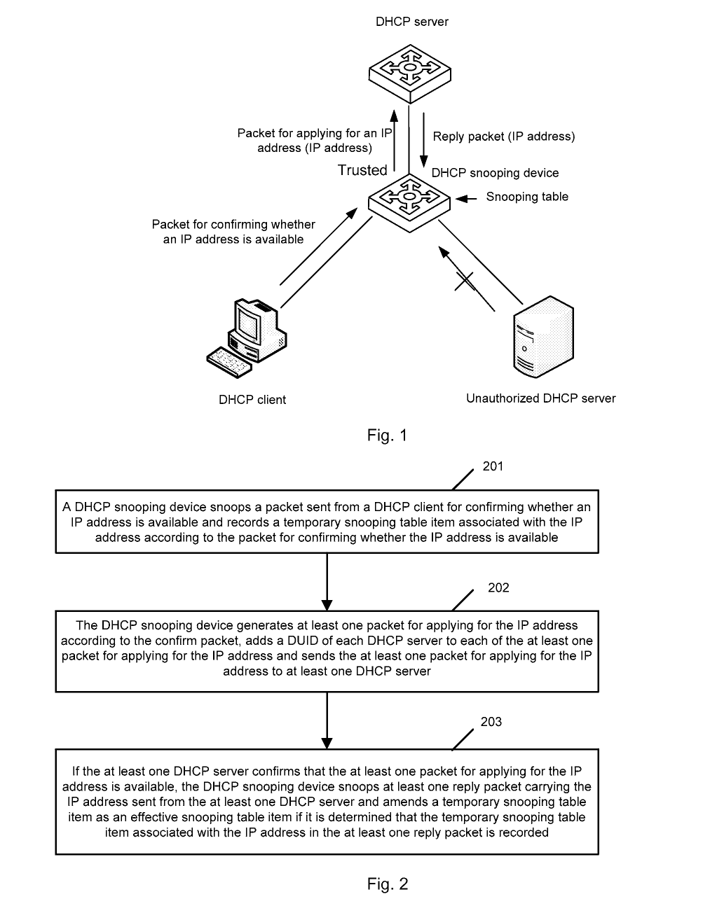

In a DHCP application network, for safety reasons, a network device with a DHCP snooping function (called a DHCP snooping device for short) is deployed between a DHCP client and a DHCP server. As shown in FIG. 1, an attribute of a port of the network device connecting the network device to the DHCP server is set as Trusted, so that the DHCP snooping device may normally forward a reply packet sent from the DHCP server to the DHCP client and the DHCP client may obtain an IP address from a trusted DHCP server.

After the DHCP client obtains the IP address, if the DHCP client restarts, wakes from a sleep status, or a physical connection status changes, the DHCP client may migrate to a new link and the DHCP client sends a confirm packet to confirm whether the IP address is available. A broadcast address of the confirm packet is an All_DHCP_Relay_Agents_and_Servers broadcast address.

After the DHCP server receives the confirm packet sent from the DHCP client, the DHCP server checks whether the IP address, the life time of which needs to be extended in the confirm packet, is available for a link, at which the DHCP client is located.

To ensure that the DHCP client may normally access a LAN, the DHCP snooping device snoops a packet sent from the DHCP client and is used for confirming whether the IP address is available. The packet may be the confirm packet and the DHCP snooping device may also generate at least one packet for applying for the IP address using the confirm packet, may send the at least one packet for applying for the IP address to the DHCP server, and may record a temporary snooping table item associated with the IP address.

After the DHCP server receives the at least one packet for applying for the IP address, the DHCP server confirms whether the IP address in the at least one packet for applying for the IP address is available and, if the IP address is available, sends at least one reply packet carrying the IP address to the DHCP snooping device.

With the above scheme, the DHCP snooping device may snoop the packet to confirm whether the IP address sent from the DHCP client is available, transform the packet for confirming whether the IP address is available into the at least one packet for applying for the IP address and send the at least one packet to apply for the IP address to at least one DHCP server. If the at least one DHCP server confirms that the IP address is available, the DHCP client may normally access the LAN using the IP address.

Various examples of methods disclosed in the present disclosure are described hereinafter.

Referring to FIG. 2, there is shown a flow chart illustrating a method in accordance with an example of the present disclosure. As shown in FIG. 2, the flow includes the following blocks.

In block 201, a DHCP snooping device may snoop a packet sent from a DHCP client for confirming whether an IP address is available and may record a temporary snooping table item associated with the IP address according to the packet to confirm whether the IP address is available.

The temporary snooping table item recorded in block 201 may at least include: the IP address to be confirmed, a Media Access Control (MAC) address of the DHCP client, a port receiving the packet for confirming whether the IP address is available and a VLAN to which the port belongs.

Since the IP address has not been confirmed by the DHCP server, the snooping table item has not come into force and may not be used. Therefore, the snooping table item is called a temporary snooping table item.

According to an example, the packet for confirming whether the IP address is available may be a confirm packet in the DHCPv6 or other packets with similar function. Hereinafter, for ease of description, the packet for confirming whether the IP address is available may be called a confirm packet.

In block 202, the DHCP snooping device may generate at least one packet for applying for the IP address according to the confirm packet, may add a DHCP Unique Identifier (DUID) to each of the at least one packet for applying for the IP address and may send the at least one packet for applying for the IP address to at least one DHCP server.

In this block, after receiving the confirm packet, the DHCP snooping device may generate the at least one packet for applying for the IP address according to the confirm packet. After the at least one packet for applying for the IP address is generated, the confirm packet may not be forwarded, i.e. the confirm packet may be discarded.

According to an example, the packet for applying for the IP address may be a request packet in the DHCPv6 or any other packet with the similar function. Hereinafter, for the ease of description, the packet for applying for the IP address may be called a request packet.

When a DHCP server receives a request packet, the DHCP server may check whether the DUID carried in the request packet is its DUID and may discard the request packet if the DUID carried in the request packet is not its DUID; otherwise, the DHCP server may obtain the IP address in the request packet. The DHCP server may confirm whether the IP address is available, may record lease information of the IP address if the DUID carried in the request packet is its DUID and may send a reply packet to the DHCP snooping device. The method for confirming whether the IP address is available may include confirming whether the IP address is available according to a principle that different DHCP clients use different IP addresses, i.e., confirming whether the IP address is idle, determining that the IP address may be allocated to the DHCP client if the IP address is idle, otherwise, determining that the IP address may not be allocated to the DHCP client, which may avoid conflict of the IP addresses. Furthermore, according to an example, the lease information of the IP address recorded by the DHCP server may at least include: the IP address, the MAC address of the DHCP client in the request packet and the lease time of the IP address.

In block 203, if the at least one DHCP server confirms that the at least one packet for applying for the IP address is available, the DHCP snooping device may snoop at least one reply packet carrying the IP address sent from the at least one DHCP server and may amend a temporary snooping table item as an effective snooping table item if it is determined that the temporary snooping table item associated with the IP address in the at least one reply packet is recorded.

The DHCP client may access the LAN according to the effective snooping table item.

If the temporary snooping table item is amended as the effective snooping table item, the snooping table item after the amendment is available.

In block 203, the DHCP snooping device may forward the at least one reply packet to the DHCP client. When the DHCP client accesses the LAN according to the IP address in at least the reply packet, since the DHCP snooping device records the effective snooping table item associated with the IP address, the DHCP snooping device may allow the DHCP client to access the LAN. Therefore, the DHCP client may normally access the LAN using the IP address.

It may be seen from the flow diagram shown in FIG. 2 that the DHCP snooping device may make a transformation for the confirm packet to interact with the DHCP server in a request/reply mode. On one hand, implementation of the flow diagram shown in FIG. 2 may guarantee that the DHCP server may record the lease information of the IP address to be confirmed in the confirm packet. On the other hand, implementation of the flow diagram shown in FIG. 2 may guarantee that the DHCP snooping device may create the snooping table item associated with the IP address to be confirmed, by which the DHCP client may access the LAN normally.

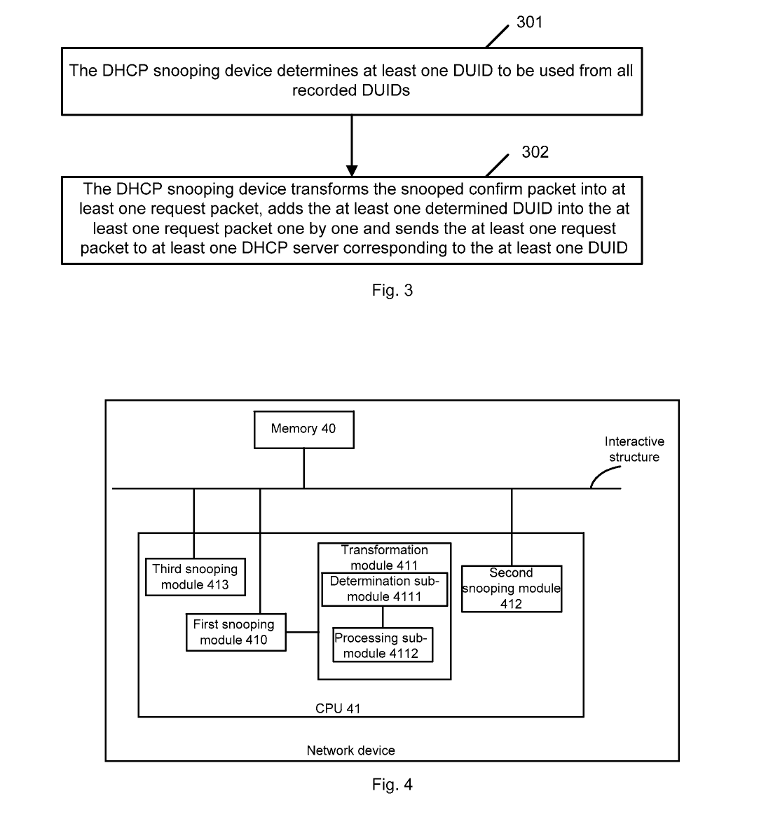

Block 202 in FIG. 2 is described hereafter in detail with respect to FIG. 3.

It should be noted that, according to an example, in order to implement block 202, the DHCP snooping device may need to record the DUID of the DHCP server before implementing block 202.

According to an example, the DHCP snooping device may record the DUID of the DHCP server via any of the following three methods.

Method one: In the network, all of the packets between the DHCP client and the DHCP server are forwarded by the DHCP snooping device. In method one, in the process in which the DHCP client applies for the IP address, the DHCP snooping device may snoop the packets, such as the confirm packet and the reply packet sent from the DHCP server to the DHCP client and may create the following table item one and table item two according to information in the packets.

Table item one includes: the MAC address of the DHCP client, the IP address applied by the DHCP client, the DUID of the DHCP server, a port snooping the packet and a VLAN, to which the port belongs. The MAC address of the DHCP client, the IP address and the DUID of the DHCP server may be obtained from the snooped packet.

Table item two includes: the DUID of the DHCP server and the port snooping the packet and the VLAN, to which the port belongs. The DUID of the DHCP server may be obtained from the snooped packet.

Since table item one includes the IP address applied by the DHCP client, the aging time of table item one depends on the lease time of the IP address applied by the DHCP client. That is, when the lease time of the IP address applied by the DHCP client expires, table item one ages out. The aging time of table item two may be set according to actual conditions. For instance, the aging time of table item two may be set as the lease time of the IP address in the snooped packet or a multiple of the lease time. A limitation on the setting of the aging time is not made in the present disclosure.

It should be noted that in method one, a packet sent from the same DHCP server may be snooped repeatedly, resulting in that the above two table items are created repeatedly. In this case, according to an example, when the DHCP snooping device snoops the packet, the DHCP snooping device checks whether the created table item includes the DUID in the snooped packet, ignores the packet in response to the created table item including the DUID, otherwise, creates the above table item one and table item two.

Method two: Since all of the packets communicated between the DHCP client and the DHCP server are forwarded by the DHCP snooping device, during application by the DHCP client for the IP address, the DHCP snooping device snoops the packet sent from the DHCP server to the DHCP client and records the DUID in the snooped packet. That is, the DUID is recorded in method two, while the port snooping the packet and the VLAN, to which the port belongs, is further recorded in method one.

It should be noted that in method two, a packet sent from the same DHCP server may be snooped repeatedly, resulting in that the DUID is recorded repeatedly. In this case, according to an example, when the DHCP snooping device snoops the packet, the DHCP snooping device checks whether the recorded DUID includes the DUID in the snooped packet, ignores the packet in response to the DUID in the snooped packet being included in the recorded DUID, otherwise, records the DUID in the snooped packet.

Method three: The DUID of each DHCP server is set on the DHCP snooping device in advance.

On the basis of the above method for recording the DUID by the DHCP snooping device, an example of a specific implementation in block 202 is further described via FIG. 3.

Referring to FIG. 3, there is shown a flow chart illustrating block 202 provided by an example of the present disclosure. As shown in FIG. 3, the flow diagram may include the following blocks.

In block 301, the DHCP snooping device may determine at least one DUID to be used from all of the recorded DUIDs.

According to an example in which the DHCP snooping device records the DUID via the above method one, block 301 includes obtaining the MAC address of the DHCP client from the snooped confirm packet, in which the IP address is to be confirmed by the confirm packet. Block 301 also includes determining whether a table item including the MAC address and the IP address is stored locally and taking a DUID in the table item as the DUID to be used in response to the table item including the MAC address and the IP address being stored locally. Otherwise, according to an example, the table item including the MAC address and IP address ages out, different DUIDs from all of the local table items are obtained, and the obtained DUIDs are taken as the DUIDs to be used in sending the packet for applying for the IP address to the DHCP servers.

According to an example in which the DHCP snooping device records the DUID via the above method two or three, block 301 includes taking all of the local DUIDs as the DUIDs to be used. In the DHCPv6 network, on the basis of method two or method three, the number of the DUID recorded by the DHCP snooping device may be one or larger than one, such as two. A limitation on the number of the DUID is not made in the present disclosure.

In block 302, the DHCP snooping device may transform the snooped confirm packet into at least one request packet, may add the at least one determined DUID into the at least one request packet one by one, and may send the at least one request packet to at least one DHCP server corresponding to the at least one DUID.

In block 302, the method for transforming the confirm packet into the at least one request packet may include stopping forwarding of the confirm packet and generating the at least one request packet by the DHCP snooping device instead of the DHCP client. That is, the confirm packet may be used for triggering the DHCP snooping device to generate the at least one request packet. The number of the request packet may be the same as that of the DUID determined in block 301. Furthermore, in block 302, the DUID may be added to the request packet via adding a server-id option in the request packet.

According to an example in which the DHCP snooping device records the at least one DUID via the above method one, in block 302, the method for sending the at least one request packet to the at least one DHCP server corresponding to the at least one DUID may include sending the at least one request packet via at least one port and VLAN in a table item corresponding to the DUID of the DHCP server. This method may guarantee that the DHCP snooping device may send the at least one request packet through less than all of the ports and therefore save resources.

According to an example in which the DHCP snooping device records the at least one DUID via the above methods two or three, in block 302, the method for sending the at least one request packet to the at least one DHCP server corresponding to the at least one DUID may include sending the at least one request packet via all of the local ports or via at least one pre-designated port.

The operation of the above block 202 may be implemented via the flow diagram shown in FIG. 3.

Examples of methods provided by the present disclosure are described above and the devices provided by the present disclosure are described hereinafter.

Referring to FIG. 4, there is shown a schematic diagram illustrating the structure of a first network device in accordance with an example of the present disclosure. The network device may be used for processing addresses and may have a DHCP snooping function. As shown in FIG. 4, the network device may include a CPU 41 and a memory 40.

The CPU 41 may include a first snooping module 410, a transformation module 411, and a second snooping module 412.

The first snooping module 410 may listen to a packet sent from a DHCP client to confirm whether an IP address is available and may record a temporary snooping table item associated with the IP address in the memory 40 according to the packet to confirm whether the IP address is available.

The transformation module 411 may generate at least one packet for applying for the IP address according to the packet for confirming whether the IP address is available, add a DUID of each DHCP server to each of the at least one packet for applying for the IP address, and may send the at least one packet for applying for the IP address to at least one DHCP server.

The second snooping module 412 may receive at least one reply packet carrying the IP address sent from the at least one DHCP server when the at least one DHCP server determines that the IP address in the at least one packet for applying for the IP address is available and may amend a temporary snooping table item in the memory 40 as an effective snooping table item if it is determined that the temporary snooping table item associated with the IP address in the at least one reply packet is recorded.

In addition, the DHCP client may access the LAN according to the effective snooping table item.

The DHCP server may send the at least one reply packet to the second snooping module 412 via the following methods.

When determining that the IP address in the at least one packet for applying for the IP address is available, a DHCP server may record lease information of the IP address and may send a reply packet to the network device. The lease information of the IP address may at least include the IP address, a MAC address of the DHCP client in the packet for applying for the IP address, and the lease time of the IP address.

According to an example, the packet for confirming whether the IP address is available is the confirm packet in the DHCPv6. In addition, the packet for applying for the IP address is the request packet in the DHCPv6.

According to an example, the memory 40 may further record the DUID of each DHCP server. On this basis, as shown in FIG. 4, the transformation module 411 may include: a determination sub-module 4111 and a processing sub-module 4112.

The determination sub-module 4111 may determine at least one DUID to be used from all of the DUIDs in the memory 40.

The processing sub-module 4112 may generate the at least one packet for applying for the IP address according to the packet for confirming whether the IP address is available, add the at least one DUID to the at least one packet for applying for the IP address one by one, and send the at least one packet for applying for the IP address to the at least one DHCP server corresponding to the at least one DUID.

According to an example, the CPU 41 may further include a third snooping module 413 that is to snoop a packet sent from the DHCP server to the DHCP client during a process in which the DHCP client applies for the IP address. On this basis, the memory 40 may record the DUID of each DHCP server via any of the following three methods.

Method one: The DUID of each DHCP server may be recorded via table item one and table item two. Table item one may include the MAC address of the DHCP client, the IP address applied by the DHCP client, the DUID of the DHCP server, a port of the third snooping module 413 snooping the packet, and a VLAN, to which the port belongs. The MAC address of the DHCP client, the IP address applied by the DHCP client and the DUID of the DHCP server may be obtained from the packet snooped by the third snooping module 413. Table item two may include the DUID of the DHCP server and the port snooping the packet and the VLAN, to which the port belongs. The DUID of the DHCP server may be obtained from the packet snooped by the third snooping module 413.

Method two: The network device may record the DUID in the packet snooped by the third snooping module 413.

Method three: The network device may record the DUID of the each configured DHCP server.

According to an example, the aging time of table item one may be determined by the lease time of the IP address applied by the DHCP client. In addition, the aging time of table item two is preset.

According to an example, the determination sub-module 4111 may determine the at least one DUID to be used from all of the recorded DUIDs by obtaining the MAC address of the DHCP client from the confirm packet when the memory 40 records the DUID of the DHCP server via method one, obtaining the IP address to be confirmed by the confirm packet, determining whether the memory 40 stores a table item including the MAC address and IP address of the DHCP client, determining the DUID in the table item as the DUID to be used if the memory 40 stores a table item including the MAC address and IP address of the DHCP client, otherwise obtaining different DUIDs from table items stored in the memory 40 and taking the obtained DUIDs as the DUIDs to be used.

When the memory 40 records the DUID of each DHCP via methods two or three, all of the recorded DUIDs in the memory 40 may be taken as the DUIDs to be used.

According to an example, the processing sub-mode 4112 may send the at least one packet for applying for the IP address to the at least one DHCP server corresponding to the at least one DUID by sending the at least one request packet for applying for the IP address via at least one port and a VLAN in a table item corresponding to the at least one DUID when the memory 40 records the DUID of each DHCP server via method one; and may send the at least one request packet for applying for the IP address via all of the local ports or a pre-designated port when the memory 40 records the DUID of the DHCP server via methods two or three.

The function of each of the above modules may be implemented by software, such as machine readable instructions stored in a memory and executed by the CPU, may be implemented by hardware, such as an Application Specific Integrated Circuit (ASIC) processor or may be implemented by a combination of software and hardware. A limitation on the implementation of the modules is not made in the present disclosure.

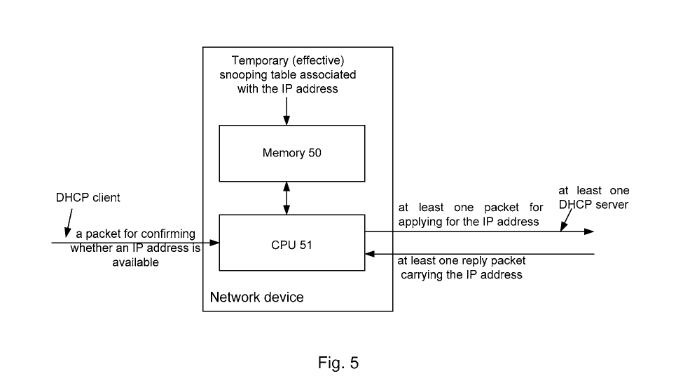

FIG. 5 is a schematic diagram illustrating the structure of a second network device in accordance with an example of the present disclosure. As shown in FIG. 5, the network device includes a CPU 51 and memory 50.

The memory 50 may store machine readable instructions.

The CPU 51 may execute the machine readable instructions stored in the memory 50 to snoop a packet for confirming whether an IP address sent from a DHCP client is available and to record a temporary snooping table item associated with the IP address in the memory 50 according to the packet to confirm whether the IP address is available. The CPU 51 may also execute the machine readable instructions stored in the memory 50 to generate at least one packet for applying for the IP address according to the packet for confirming whether the IP address is available, add a DHCP Unique Identifier (DUID) of a DHCP server to each of the at least one packet for applying for the IP address, and send the at least one packet for applying for the IP address to at least one DHCP server. The CPU 51 may further execute the machine readable instructions stored in the memory 50 to receive, when the at least one DHCP server confirms that the IP address identified in the at least one packet for applying for the IP address is available, at least one reply packet carrying the IP address sent from the at least one DHCP server and amend the temporary snooping table item in the memory 50 as an effective snooping table item if it is determined that the temporary snooping table item associated with the IP address in the at least one reply packet is recorded.

The DHCP client may access the LAN according to the effective snooping table item.

The at least one reply packet carrying the IP address sent from the at least one DHCP server may be received via the following methods.

When the at least one DHCP server determines that the IP address in the at least one packet for applying for the IP address is available, the at least one DHCP server records the lease information of the IP address and sends the at least one reply packet to the network device. The lease information of the IP address at least includes the IP address, the MAC address of the DHCP client in the at least one packet for applying for the IP address, and the lease time of the IP address.

The CPU 51 may further execute the machine readable instructions to determine at least one DUID to be used from all of the DUIDs recorded in the memory 50, generate the at least one packet for applying for the IP address according to the packet for confirming whether the IP address is available, add the at least one DUID to the at least one packet for applying for the IP address one by one and send the at least one packet for applying for the IP address to the at least one DHCP server corresponding to the at least one DUID.

The CPU 51 may further execute the machine readable instructions to snoop a packet sent from the DHCP server to the DHCP client during a process in which the DHCP client applies for the IP address.

The memory 50 may further record the DUID of the each DHCP server via any of following three methods:

Method one: the DUID of each DHCP server is recorded via table item one and table item two. Table item one may include: a Media Access Control (MAC) address of the DHCP client, the IP address applied by the DHCP client, the DUID of the DHCP server, a port snooping the packet, and a VLAN to which the port belongs. The MAC address of the DHCP client, the IP address applied by the DHCP client, and the DUID of the DHCP server may be obtained from the snooped packet. The table item two may include: the DUID of the DHCP server, the port snooping the packet, and the VLAN to which the port belongs, and the DUID of the DHCP server may be obtained from the snooped packet.

Method two: The network device records the DUID in the snooped packet.

Method three: The network device records the configured DUID of the each DHCP server.

According to an example, the aging time of table item one may be determined according to the lease time of the IP address applied by the DHCP client in table item one and the aging time of table item two may be preset.

The CPU 51 may further execute the machine readable instructions to obtain, when the memory 50 records the DUID of the each DHCP server via method one, the MAC address of the DHCP client from the confirm packet, obtain the IP address to be confirmed by the confirm packet, determine whether a table item comprising the MAC address and IP address of the DHCP client is stored in the memory 50, determine the DUID in the table item as the DUID to be used if the table item comprising the MAC address and the IP address of the DHCP client is stored in the memory 50, otherwise obtain different DUIDs from all of the table items stored in the memory 50 and take the obtained DUIDs as the DUIDs to be used; and take, when the memory 50 records the DUID of the each DHCP server via method two or method three, all of the DUIDs stored in the memory 50 as the DUIDs to be used.

The CPU 51 may further execute the machine readable instructions to send the at least one request packet for applying for the IP address via at least one port and a VLAN in a table item corresponding to the at least one DUID when the memory 50 records the DUID of the each DHCP server via method one; and send the at least one request packet for applying for the IP address via all of the local ports or at least one pre-designated port when the memory 50 records the DUID of the each DHCP server via method two or method three.

It can be seen from the discussion above, that in the present disclosure, the network device with the DHCP snooping function may generate at least one packet for applying for the IP address, such as the request packet according to the packet for confirming whether the IP address is available. The network device with the DHCP snooping function may send the at least one request packet to the at least one DHCP server. When the DHCP server confirms that the IP address in the request packet is available, the at least one DHCP server may send at least one reply packet carrying the IP address to the network device with the DHCP snooping function. When the network device with the DHCP snooping function confirms that the temporary snooping table item associated with the IP address in the at least one reply packet is recorded, the network device with the DHCP snooping function may amend the temporary snooping table item as the effective snooping table item. Therefore, the DHCP client may access the LAN with the requested IP address.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An address processing method, applied in a network device with a Dynamic Host Configuration Protocol (DHCP) snooping function, comprising:
snooping, by the network device, a packet sent from a DHCP client for confirming whether an IP address is available and recording a temporary snooping table item associated with the IP address according to the snooped packet;
generating, by the network device, at least one packet for applying for the IP address according to the snooped packet, adding a DHCP Unique Identifier (DUID) of a DHCP server to each of the at least one packet and sending the at least one packet for applying for the IP address to a DHCP server; and
in response to a confirmation by the DHCP server that the IP address is available, receiving, by the network device, at least one reply packet sent from the DHCP server carrying the IP address and amending the temporary snooping table item as an effective snooping table item in response to a determination that the temporary snooping table item associated with the IP address in the at least one reply packet is recorded.

2. The method according to claim 1, wherein:
the packet for confirming whether the IP address is available is a confirm packet in DHCPv6; and
the at least one packet for applying for the IP address is a request packet in the DHCPv6.

3. The method according to claim 1, further comprising:
recording, by the network device, the DUID of each of a plurality of DHCP servers;
wherein generating, by the network device, the at least one packet for applying for the IP address according to the packet, adding the DUID of the DHCP server to each of the at least one packet for applying for the IP address and wherein sending the at least one packet for applying for the IP address to the DHCP server comprises:
determining the DUID to be used from all of the recorded DUIDs; and
generating the at least one packet for applying for the IP address, adding the DUID to the at least one packet for applying for the IP address one by one and sending the at least one packet for applying for the IP address to the DHCP server corresponding to the determined DUID.

4. The method according to claim 3, wherein recording, by the network device, the DUID of the each of the plurality of DHCP servers comprises: recording, by the network device, the DUID of the each of the plurality of DHCP servers via one of the following:
a) snooping, by the network device, a packet sent from the DHCP server to the DHCP client, creating a table item one and a table item two according to the snooped packet, wherein the table item one comprises: a Media Access Control (MAC) address of the DHCP client, the IP address applied for by the DHCP client, the DUID of the DHCP server, a port snooping the packet, and a VLAN to which the port belongs; wherein the MAC address of the DHCP client, the IP address applied for by the DHCP client and the DUID of the DHCP server are obtained from the snooped packet, wherein the table item two comprises: the DUID of the DHCP server, the port snooping the packet and the VLAN, to which the port belongs and the DUID of the DHCP server is obtained from the snooped packet;
b) snooping, by the network device, the packet sent from the DHCP server to the DHCP client and recording the DUID in the snooped packet; and
c) setting, on the network device, the DUID of the DHCP server on the network device.

5. The method according to claim 4, wherein:
an aging time of the table item one is determined according to a lease time of the IP address for which the DHCP client sends the packet; and
the aging time of table item two is preset.

6. The method according to claim 4, wherein determining the at least one DUID to be used from all of the recorded DUIDs comprises:
obtaining, when the network device records the DUID of each of the plurality of DHCP servers via a), the MAC address of the DHCP client from the packet for confirming whether the IP address is available, obtaining the IP address to be confirmed, determining whether a table item comprising the MAC address and the IP address of the DHCP client is stored locally, determining the DUID in the table item as the DUID to be used in response to the table item comprising the MAC address and the IP address of the DHCP client stored locally, otherwise obtaining different DUIDs from all of the table items created locally and taking the obtained DUIDs as the DUIDs to be used; and
taking, when the network device records the DUID of each of the plurality of DHCP servers via b) or c), all of the DUIDs stored locally as the DUIDs to be used.

7. The method according to claim 4, wherein sending the at least one packet for applying for the IP address to the DHCP server corresponding to the at least one DUID comprises:
sending the at least one packet for applying for the IP address via at least one port and a VLAN in a table item corresponding to the DUID when the network device records the DUID of each of the plurality of DHCP servers via a); and
sending the at least one packet for applying for the IP address via all of a plurality of local ports or at least one pre-designated port when the network device records the DUID of each of the plurality of DHCP servers via b) and c).

8. A network device, with a Dynamic Host Configuration Protocol (DHCP) snooping function, comprising a central processing unit (CPU) and a memory; wherein
the memory is to store machine readable instructions;
the CPU is to execute the machine readable instructions in the memory to:
snoop a packet sent from a DHCP client for confirming whether an IP address is available and record, in the memory, a temporary snooping table item associated with the IP address according to the snooped packet;
generate at least one packet for applying for the IP address according to the snooped packet, add a DHCP Unique Identifier (DUID) of each DHCP server to each of the at least one packet for applying for the IP address and send the at least one packet for applying for the IP address to a DHCP server; and
receive, in response to a confirmation by the DHCP server that the IP address is available, at least one reply packet sent from the DHCP server carrying the IP address and amend the temporary snooping table item in the memory as an effective snooping table item in response to a determination that the temporary snooping table item associated with the IP address in the at least one reply packet is recorded in the memory.

9. The network device according to claim 8, wherein
the memory is further to record the DUID of each of a plurality of DHCP servers; and
the CPU is further to execute the machine readable instructions to determine a DUID to be used from all of the recorded DUIDs;
generate the at least one packet for applying for the IP address, add the determined DUID to the at least one packet for applying for the IP address one by one and send the at least one packet for applying for the IP address to the DHCP server corresponding to the at least one DUID.

10. The network device according to claim 9, wherein:
the CPU is further to execute the machine readable instructions to:
snoop a packet sent from the DHCP server to the DHCP client; and
the memory is further to record the DUID of the each of the plurality of DHCP servers via one of following:
a) create a table item one and a table item two, wherein the table item one comprises: a Media Access Control (MAC) address of the DHCP client, the IP address applied for by the DHCP client, the DUID of the DHCP server, a port snooping the packet, and a VLAN to which the port belongs; wherein the MAC address of the DHCP client, the IP address applied for by the DHCP client and the DUID of the DHCP server are obtained from the snooped packet, wherein the table item two comprises: the DUID of the DHCP server, the port snooping the packet and the VLAN, to which the port belongs and the DUID of the DHCP server is obtained from the snooped packet;
b) record the DUID in the snooped packet; and
c) record the configured DUID of the DHCP server.

11. The network device according to claim 10, wherein:
an aging time of the table item one is determined according to a lease time of the IP address for which the DHCP client sent the packet; and
the aging time of table item two is preset.

12. The network device according to claim 10, wherein the CPU is further to execute the machine readable instructions to:
obtain, when the memory records the DUIDs of the plurality of DHCP servers via a), the MAC address of the DHCP client from the packet for confirming whether the IP address is available, obtain the IP address to be confirmed, determine whether a table item comprising the MAC address and IP address of the DHCP client is stored in the memory, determine the DUID in the table item as the DUID to be used if the table item comprising the MAC address and the IP address of the DHCP client is stored in the memory, otherwise obtain different DUIDs from all table items stored in the memory and take the obtained DUIDs as the DUIDs to be used; and
take, when the memory records the DUID of each of the plurality of DHCP servers via b) or c), all of the DUIDs stored in the memory as the DUIDs to be used.

13. The network device according to claim 10, wherein the CPU is further to execute the machine readable instructions to:
send the at least one packet for applying for the IP address via at least one port and a VLAN in a table item corresponding to the DUID when the memory records the DUID of each of the plurality of DHCP servers via a); and
send the at least one packet for applying for the IP address via all of a plurality of local ports or at least one pre-designated port when the memory records the DUID of the each of the plurality of DHCP servers via b) or c).
